(19) United States
(12) Patent Application Publication
(10) Pub. No.: US 2006/0251205 A1
(43) Pub. Date: Nov. 9, 2006

(54) In-core fuel restraint assembly

(75) Inventor: Leonard J. Balog, Naples, FL (US)

Correspondence Address: WESTINGHOUSE ELECTRIC COMPANY, LLC, P.O. BOX 355, PITTSBURGH, PA, 15230-0355, US

(73) Assignee: Westinghouse Electric Co. LLC

(21) Appl. No.: 11/120,265

(22) Filed: May 2, 2005

(51) Int. Cl. G21C 15/00

(52) U.S. Cl. 376/362

(57) ABSTRACT

An in-core restraint assembly is for a nuclear reactor core including an upper core plate, a lower core support plate and a plurality of fuel assemblies extending longitudinally therebetween. Each fuel assembly includes top and bottom nozzles and a plurality of elongated fuel rods extending therebetween. The in-core restraint assembly includes a first restraint element, such as a spring pack, coupled to the upper core support plate and providing a substantially axial compressive force on the top nozzle of the fuel assembly. An optional second restraint element is structured to be coupled to the lower core plate in order to engage and further restrain the fuel assembly proximate the bottom nozzle. The second restraint element includes a pin member extending from the bottom nozzle of the fuel assembly and received in a socket coupled to the lower core support plate, whereby this mating sustains a longitudinal (vertical) frictional force which must be overcome before fuel assembly lift off can occur.

### BACKGROUND OF THE INVENTION

1. Field of the Invention

The present invention relates generally to fuel assemblies for a nuclear reactor core and, more particularly, to an in-core restraint assembly for securing the fuel assemblies between upper and lower core plates.

2. Background Information

The reactor core within a typical commercial nuclear power reactor is formed by numerous elongated fuel assemblies arranged in a cylindrical vessel.

As shown in FIG. 1, each fuel assembly 2 generally includes top and bottom nozzles 4,6 with a plurality of transversally spaced guide thimbles 8 extending longitudinally between the nozzles 4,6, a number of transverse support grids 10 axially spaced along and attached to the guide thimbles 8, an organized array of elongated fuel rods 12 transversely spaced and supported by the support grids 10, and a centrally located instrument tube 14. The top and bottom nozzles 4,6 have end plates (not shown) with flow openings (not shown) for facilitating the upward longitudinal flow of a fluid coolant (e.g., without limitation, water). The coolant passes up and over the outer surface of the fuel rods 12, in order to receive thermal energy therefrom. To disperse the coolant among the fuel rods 12, mixing vane grid structures, (one mixing vane is indicated generally as reference 16 in the simplified, sectioned view of FIG. 1) is disposed between a pair of support grids 10 and is mounted on the guide thimbles 8. A rod cluster control assembly 18, generally located at the middle of the top nozzle 4, includes radially extending flukes 20 coupled to the upper ends of the control rods for vertically moving the control rods within the control rod guide thimbles 8. A more detailed description of the fuel assembly 2 is provided, for example, in U.S. Pat. No. 4,061,536.

Typically, the fuel assembly 2 is secured within the cylindrical vessel (not shown in FIG. 1), between upper and lower core plates (not shown in FIG. 1) by a plurality of compressive springs such as coil springs (not shown), which are integral with the top nozzle 4, and/or by cantilever springs 22 (e.g., leaf springs). FIG. 1 shows one compressive spring of the leaf, or cantilever 22, variety. The cantilever springs 22 are affixed to the top nozzle 4 and extend radially therefrom. However, they may also be coupled to the upper core plate (not shown) or to the calandria (not shown). In general, the calandria is the area above the upper core plate which includes, for example, guide mechanisms for the fuel assemblies. In this manner, a compressive axial load is applied to the fuel assembly 2 in order to clamp it in place and resist, for example, hydraulic lifting and vibration due to coolant flow forces and, to allow for changes in fuel assembly length due to phenomenon such as core induced thermal expansion. Conventionally, each fuel assembly 2 is secured by four of the cantilever-type springs 22 (one cantilever spring 22 is shown in the side view of FIG. 1).

To be effective, the clamping forces provided by the aforementioned compressive springs, whether of the cantilever or the coil variety, must be substantial and can, therefore, result in damage to elements of the fuel assembly 2. The axially compressive nature of the spring force frequently causes an undesirably high amount of column bowing of the fuel elements (e.g., fuel rods 12 and guide thimbles 8). Column bowing can result in disadvantages such as, for example, partial control rod insertion and slower scram times. Scram is a term which has evolved in the nuclear art to be commonly used when referring to an emergency shutdown of a nuclear reactor.

In an attempt to both avoid damage to the fuel elements and to provide maximum restraining forces, a variety of in-core restraint devices have been designed and employed, each of which has its own set of unique disadvantages.

For example, U.S. Pat. No. 4,624,829 (Jackson) discloses a nuclear fuel assembly channel spring and stop assembly. A combination of springs employed in order to maintain spacing between adjacent fuel assemblies and to secure individual fuel rods within the assemblies, is disclosed. Specifically, a plurality of elongated compression springs are disposed over vertical extensions of the fuel rod upper end plugs in order to react against the lower surface of the upper tie plate and to maintain the fuel rods seated in the lower tie plate. Additionally, bi-directional leaf springs are mounted to the edge of the fuel assembly at the tie plate in order to maintain spacing between adjacent fuel assemblies and to transmit loads from one fuel assembly to another. However, the disclosed spring combination does not address axial compression of the entire fuel assembly in order to provide vertical restraint, without causing undesirable bowing of the fuel elements between the upper and lower core plates.

U.S. Pat. No. 4,793,965 (Altman et al.) discloses a flexible top end support for cantilever-mounted rod guides of a pressurized water reactor. Leaf springs are attached to the lower surface of the lower calandria plate in order to resiliently load the top surfaces of the reactor control rod cluster (RCC) top plates and to simultaneously generate sufficient lateral frictional force to resist slipping which is typically caused by fluctuating steady state loads applied to the guides. Two parallel pairs of the leaf are present for a total of four springs. The springs of each pair are displaced from one another by 180 degrees about the generally circular cross-section of the RCC calandria tube. However, in addition to generating high-magnitude compressive forces, which is the leading culprit for undesirable fuel element column bowing, the leaf springs are also bulky, taking up precious space within the core.

More recently, complex spring elements have been created with the intent of maximizing contact area and thus frictional restraining forces on the fuel elements in order to reduce requisite compressive forces on the elements and thus avoid damage thereto. For example, U.S. Pat. No. 6,144,716 discloses diagonal fuel retaining springs for the fuel assembly support grid. The springs include a combination of slits and dimples for providing axial, lateral and rotational restraint against fuel rod motion during reactor operation. Such springs are used in high quantities within the support grids in order to form a generally egg crate-type grid structure primarily intended to maintain separation between the fuel elements. While such a design is able to provide some resistance to axial movement, the springs are not capable of generating the axial compressive loads necessary to prevent, for example, hydraulic lift-up of the fuel assembly.

A still further disadvantage associated with most known in-core restraint mechanisms is the fact that the restraining elements (e.g., springs) employed to hold down the fuel assemblies, are typically discarded along with the spent fuel assembly. Typical fuel assembly life can be expected to be three cycles of operation, or approximately 54 months. Therefore, providing new springs at each reload is a recurring cost which can get expensive. It also creates added radioactive material to be disposed of or stored. The effective length of the fuel assembly is also increased which undesirably results in longer shipping containers and storage cells on the spent fuel pit and fuel transfer devices.

There is room, therefore, for improvement in in-core restraint assemblies for securing nuclear reactor core components.

### SUMMARY OF THE INVENTION

These needs and others are satisfied by the present invention, which is directed to an in-core fuel restraint assembly which replaces conventional compressive coil and cantilever-type spring restraining devices with a combination of restraint elements which provide superior restraint of the fuel assembly, improving resistance to lifting and vibration while simultaneously reducing harmful compressive forces applied to the fuel assembly. Additionally, among other improvements, the compact and efficient design of the in-core restraint assembly of the present invention also reduces the overall length of the fuel assembly, thereby improving the handling and disposal thereof.

As one aspect of the invention, an in-core restraint assembly is for a nuclear reactor core including an upper core support plate, a lower core support plate and a plurality of fuel assemblies extending longitudinally therebetween. Each of the fuel assemblies includes a top nozzle, a bottom nozzle and a plurality of elongated fuel rods extending therebetween. The in-core restraint assembly comprises: a first restraint element structured to be coupled to the upper core support plate and to provide a substantially axial compressive force on the top nozzle of the fuel assembly; and a second restraint element structured to be coupled to the lower core plate in order to engage and further restrain the fuel assembly proximate the bottom nozzle. The second restraint element may include a pin member and a socket, the pin member being structured to extend from the bottom nozzle of the fuel assembly, the socket being structured to be coupled to the lower core support plate and adapted to receive the pin member.

The first restraint element may be a spring pack comprising: a housing enclosing a resilient member, the housing including a top end and a bottom end; and a push rod, wherein the resilient element and the push rod are structured to be received within the counter-bore of the upper core plate and, the bottom end of the housing is structured to be coupled to the top surface of the upper core plate. Each of the fuel assemblies may include two of the spring packs.

The pin member may be a split-pin including a first end structured to be disposed in the bottom nozzle of the fuel assembly and, a second end structured to protrude below the bottom nozzle, wherein the second end of the split-pin includes an elongated slot defining a pair of leaves, the leaves being compressible laterally in order to provide a frictional resistance force when inserted into the socket. The socket may consist of a machined member having a bore with a diameter, the diameter being smaller than the outer diameter of the pair of leaves of the split-pin, wherein the split-pin is structured to be force-fit within the bore of the machined member. The socket may include a radial flange having a number of holes each structured to receive a fastener therethrough, in order to secure the socket to the lower core support plate.

As another aspect of the invention, a nuclear reactor core comprises: an upper core support plate; a lower core support plate; a plurality of fuel assemblies extending longitudinally between the upper core support plate and the lower core support plate, each of the fuel assemblies including a top nozzle, a bottom nozzle and a plurality of elongated fuel rods extending therebetween; and an in-core restraint assembly for securing the fuel assemblies between the upper and lower core support plates, the in-core restraint assembly comprising: a first restraint element coupled to the upper plate and structured to provide a substantially axial compressive force on the top nozzle of the fuel assembly, and a second restraint element coupled to the lower core plate, the second restraint element structured to engage and further restrain the fuel assembly proximate the bottom nozzle. The second restraint element may include a pin member and a socket, the pin member extending from the bottom nozzle of the fuel assembly, the socket being coupled to the lower core support plate in order to receive the pin member.

### BRIEF DESCRIPTION OF THE DRAWINGS

A full understanding of the invention can be gained from the following description of the preferred embodiments when read in conjunction with the accompanying drawings in which:

FIG. 1 is a partially-sectioned elevational view of a nuclear fuel assembly having a prior art cantilever-type spring restraint mechanism;

FIG. 2 is a cross-sectional view of the bottom two-thirds of a nuclear reactor vessel and core, with certain internal structures removed for simplicity of illustration and a simplified view of an in-core fuel restraint assembly in accordance with the present invention;

FIG. 3 is a cross-sectional close-up view of a spring pack element for the in-core restraint assembly of FIG. 2 shown as employed on the upper core plate to provide a compressive axial force to the fuel assembly top nozzle;

FIG. 4 is a schematic plan view of four adjacent corners of the top nozzles of four different fuel assemblies, showing the spring pack of FIG. 3 as employed to engage one of the corners;

FIG. 5 is an exploded, cross-sectional view of a split-pin and receptacle assembly for the in-core restraint assembly of FIG. 2; and

FIG. 6 is a plan view of flow hole patterns in the bottom nozzle of a fuel assembly modified to accommodate the in-core restraint assembly of the invention.

FIGS. 7A, 7B, 7C and 7D are fuel assembly free body diagrams in which: FIGS. 7A and 7B show the forces imposed under hot (FIG. 7A) and cold (FIG. 7B) conditions and beginning and end of life fuel assembly conditions on a fuel assembly using the prior art cantilever-type spring restraint of FIG. 1, and FIGS. 7C and 7D show the forces imposed under hot (FIG. 7C) and cold (FIG. 7D) conditions and beginning and end of life fuel assembly conditions, by the in-core restraint assembly of FIG. 2.

FIG. 8 is a plan view of the top nozzle for a fuel assembly modified to accommodate the in-core restraint assembly of the invention.

### DESCRIPTION OF THE PREFERRED EMBODIMENTS

The in-core restraint assembly of the present invention will be described as providing axial, lateral and rotational restraint against undesired movement of fuel assemblies, for example, without limitation, during reactor operation under the force of coolant flow, during seismic disturbances, or in the event of external impact. However, it will become apparent that it could also be employed in order to individually restrain other core components (e.g., without limitation, individual fuel rods; control rods) in order to resist any form of undesirable motion caused by any type of movement-generating event.

Directional phrases used herein, such as, for example, left, right, top, bottom, upper, lower and derivatives thereof, relate to the orientation of the elements shown in the drawings and are not limiting upon the claims unless expressly recited therein.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

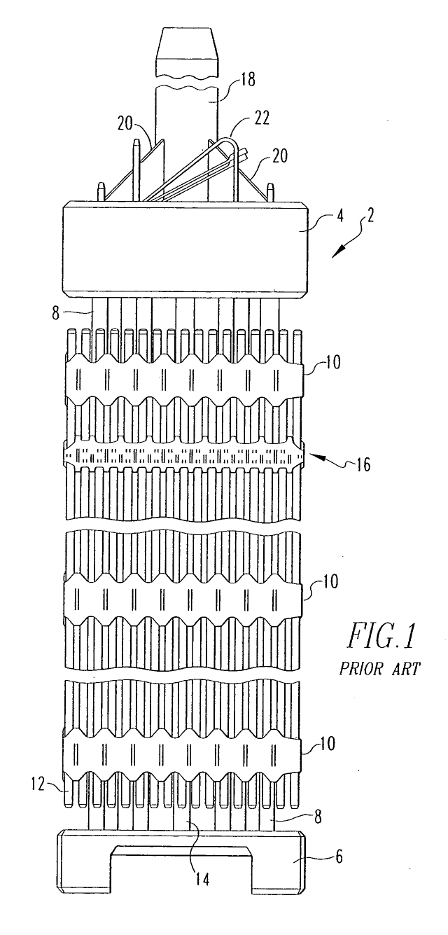

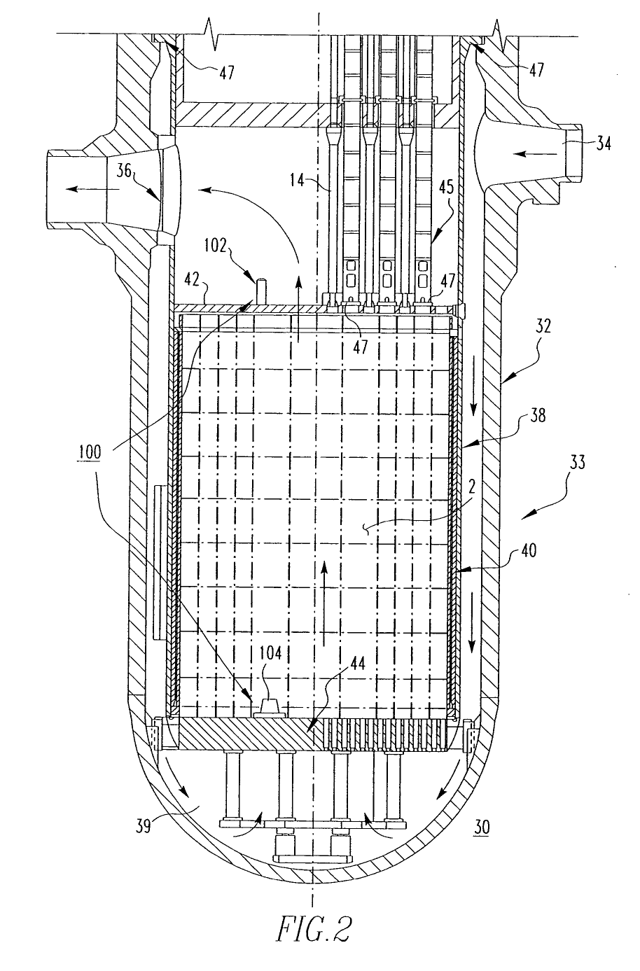

FIG. 2 shows a nuclear reactor core 30 for a commercial nuclear power reactor. The components and functional details of the reactor core 30 are generally old and well known in the art. For example, a detailed description of the core 30 can be found in The Scientific Encyclopedia, Van Nostrand, pp. 2208-2209, 8th ed., 1995. In general, the core 30 is housed within a reactor vessel 32 designed to contain the fuel assemblies 2 and control element assemblies 18 discussed previously in connection with FIG. 1, and a variety of additional internal structures required to support the core 30. Typically, the reactor vessel 32 is an Inconel clad, thick-walled, carbon steel pressure vessel comprised of a cylinder with two hemispherical halves, an upper half (not shown) and a lower half 33, which are joined by a forged ring, or vessel flange (not shown). The vessel 32 includes inlet and outlet nozzles 34, 36 located radially below the vessel flange. The fuel assemblies (indicated generally in FIG. 2 as reference 2) are disposed within a lower core barrel 38, which is defined by a core shroud 40 or a core baffle/former configuration. Both have an outer cylindrical configuration concentric with respect to the lower core barrel and both concepts present a staircase-type geometry which forms a perimeter surrounding the array of fuel assemblies. The upper core plate 42 is an integral part of the upper internals assembly (not shown) and the lower core plate 44 is affixed to the lower core barrel 38 by a complete circumferential weld. Unlike known restraint mechanisms (e.g., cantilever springs 22 discussed previously in connection with FIG. 1), which impose excessively high and thus harmful compressive forces on the fuel assemblies 2 (e.g., without limitation, when, reactant coolant forces are created or the fuel assemblies 2 become longer (e.g., added fuel length) creating a greater axial pressure differential and making the lower fuel assembly 2 more susceptible to column bowing), the present invention overcomes these disadvantages by employing an in-core fuel restraint assembly 100 which reduces the axial forces on the tops of the fuel assemblies 2, in order to alleviate the column bowing problem. The restraint assembly 100 of the invention also reduces harmful lateral compressive forces known to be exerted on the fuel assemblies 2 by certain prior art restraint mechanisms.

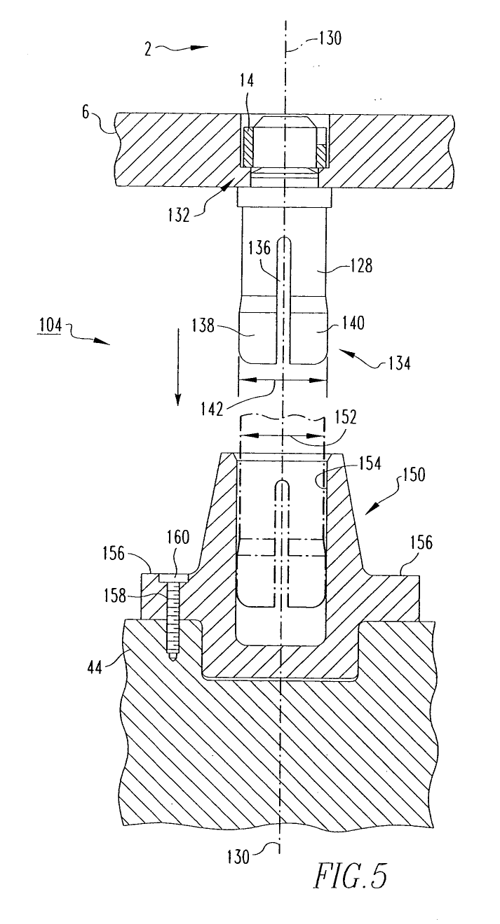

The exemplary in-core restraint assembly 100 comprises a combination of restraint elements (indicated schematically as references 102 and 104 in FIG. 2) located at the top core plate 42 and at the bottom core plate 44, respectively. However, it will be appreciated that in other embodiments of the invention, only one of the restraint elements (e.g., 102) is required. The exemplary restraint elements, as will be discussed in greater detail hereinbelow, are specially designed spring packs 102 and a novel split-pin assembly 104. The split-pin assembly 104 includes a socket or receptacle 150 (discussed in further detail herein with respect to FIG. 5) structured to receive the split-pin which is disposed at the bottom ends of the fuel assemblies 2. The split-pin assembly 104 is structured to provide an optimum balance of compression and friction which, in combination with the reduced axial compression forces of the exemplary spring packs 102, at the top nozzle 4, sufficiently restrain the fuel assembly 2 while substantially resisting column bowing and other harmful, compression related effects.

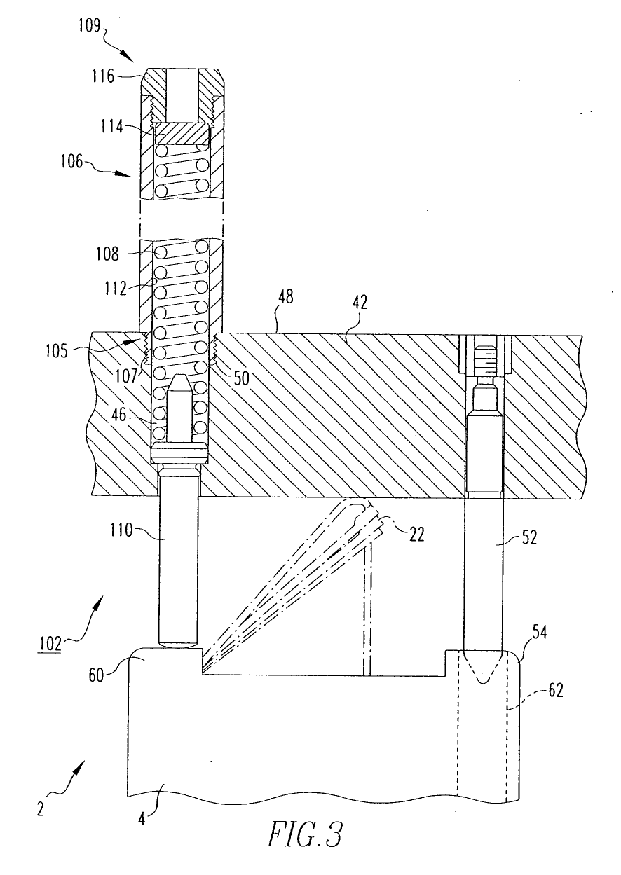

FIG. 3 shows a spring pack 102 for the exemplary in-core restraint assembly 100 of the invention. Each spring pack 102 includes a housing 106 enclosing a resilient member, such as the coil spring 108 shown, and a push rod 110. The exemplary coil spring 108 and push rod 110 are received within a counter-bore 46 in the upper core plate 42. The bottom of the housing 106 couples to the top surface 48 of the upper core plate 42. In the example of FIG. 3, this connection is accomplished by way of a male thread 107 on the bottom end 105 of the housing 106 which is threadingly received within the counter-bore 46 by way of a corresponding female thread 50 at a portion counter-bore 46 proximate the top surface 48 of the upper core plate 42. The housing 106 receives the exemplary coil spring 108 in a through bore 112. A retainer element 114 such as a disc, and a cap 116 are secured (e.g., threaded) within the top end 109 of the housing 106 adjacent the spring 108, in order to hold the assembly together.

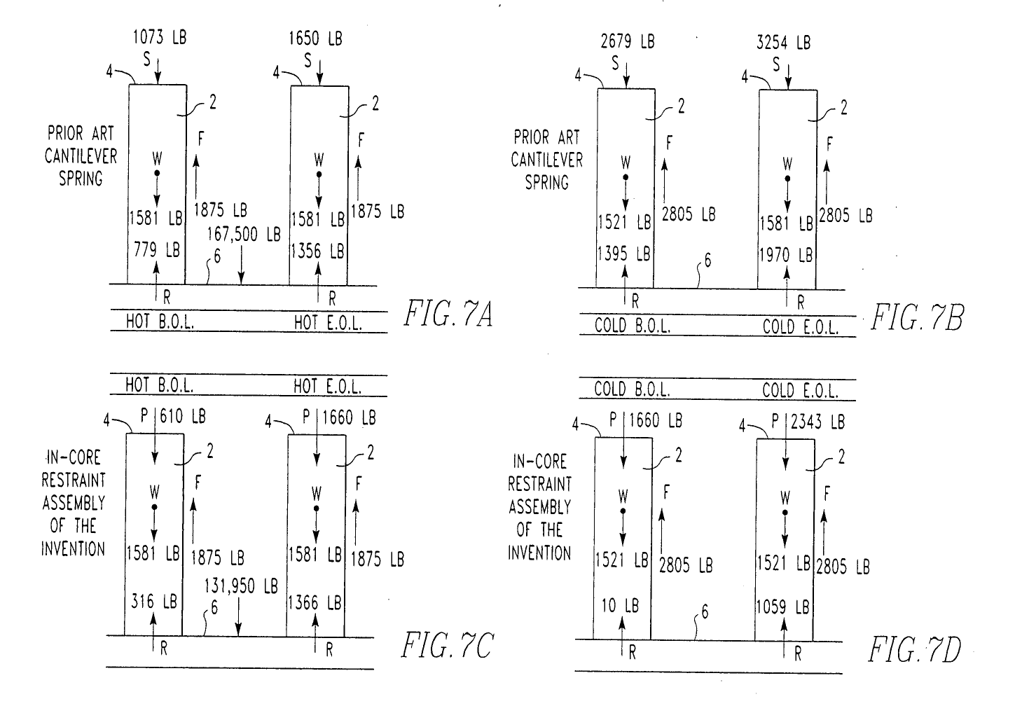

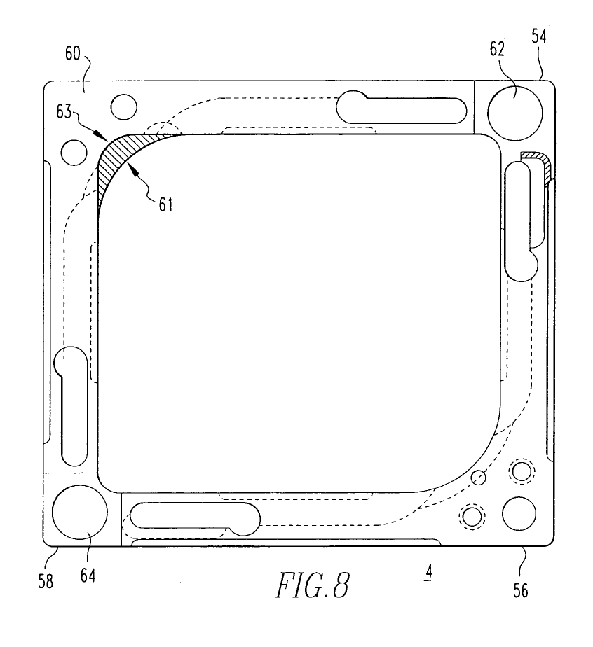

In operation, as upper internal components are inserted into the lower core barrel 38 (not shown in FIG. 3) and assembled onto a loaded core 30 (FIG. 2), each push rod 110 comes into bearing on a corner 60 of the fuel assembly top nozzle 4, as shown in FIG. 3. As descent is completed, the push rod 110 recedes up through the upper core plate 42 compressing the coil spring 112. A variety of compression lengths ensue based, for example, upon the life stages (e.g., amount of burn-up) of each fuel assembly 2. For example, under cold conditions, the height of a fuel assembly 2 can vary about 1.65 inches (4.19 centimeters) between a new assembly 2 (e.g., beginning of life (BOL) assembly) and one that is at the end of its life (EOL). Therefore, the clamping force of the spring packs 102 varies correspondingly with such factors (e.g., without limitation, temperature; life stage of the fuel). FIGS. 7A, 7B, 7C and 7D, discussed hereinbelow, further illustrate the loads experienced by the fuel assembly 2 under these varying conditions. In the exemplary embodiment discussed herein, two spring packs 102 are affixed to the upper core plate 42 for each fuel assembly 2 position in the core 30 (FIG. 2) to exert compressive loads on diagonal corners 60 (see also, opposite corner 56 of FIG. 8) of the fuel assembly 2. For simplicity of illustration, however, only one spring pack 102 is shown engaging corner 60 of fuel assembly top nozzle 4, in FIG. 3. It will be appreciated, however, that any suitable number and configuration of spring packs 2 other than the one shown and described herein, could be employed.

In view of the foregoing, the spring packs 102 of the invention replace the prior art cantilever springs 22 (shown in phantom line drawing) and substantially resolve the aforementioned disadvantages associated therewith. It should also be noted that the exemplary spring packs 102 of the invention are mounted on top of the core plate 42 and, as such, have the benefit of the shielding that the plate 42 and the push rod provide, making them less susceptible to Irradiation Assisted Stress Corrosion Cracking (IASCC) commonly experienced by other restraint devices which are disposed on top of the fuel assemblies 102 below the upper core plate 42. Nonetheless, the spring packs 102 of the invention are readily accessible, for example, during a refueling outage.

The spring pack 102 design is such that a spring can be removed (e.g., for destructive testing) and replaced without any delay in the refueling episode. In fact, the entire spring pack 102 can be readily removed and replaced if the need should ever arise.

Under all conditions, enough fuel assembly restraint must be provided to assure that fuel elements 12 do not lift off of their base (e.g., bottom core plate 44) during plant operation. Unlike other known restraint mechanism designs (e.g., cantilever springs 22) that risk damaging the fuel elements 12, or causing column bowing thereof by providing increased compressive or clamping force on the fuel assemblies 2 in order to accommodate increased restraint requirements, the spring packs 102 of the invention, in combination with the exemplary split-pin assembly 104 (FIG. 5) (discussed further herein below), substantially eliminate damaging, localized compressive forces by distributing the axial load across the upper nozzle 4 and supplementing that restraint with friction and a non-harmful amount of compression supplied at the bottom core plate 44 by way of the split-pin assembly 104 (FIG. 5).

### EXAMPLE

By way of a representative example, which will be used for illustrative purposes herein throughout, and which is not limiting upon the scope of the invention, Westinghouse Electrical Company LLC has a known core design which is commercially available under the designation AP-1000. Westinghouse Electric Company LLC has a place of business in Monroeville, Pa. The AP-1000 design includes 157 fuel assemblies 2. Therefore, in accordance with the aforementioned restraint assembly 100 of the invention, two spring packs 102 would be employed at each fuel assembly 2 location in the core 30, for a total of 314 spring packs 102.

As previously discussed, the push rod 110 of each spring pack 102 engages and provides a compressive force at a corner (see, for example, corner 60 of fuel assembly top nozzle 4 of FIG. 3) of the fuel assembly top nozzle 4. More specifically, as shown in FIG. 3, in the AP-1000 Example, the push rod 110 of spring pack 102 engages corner 60 of the top nozzle 4.

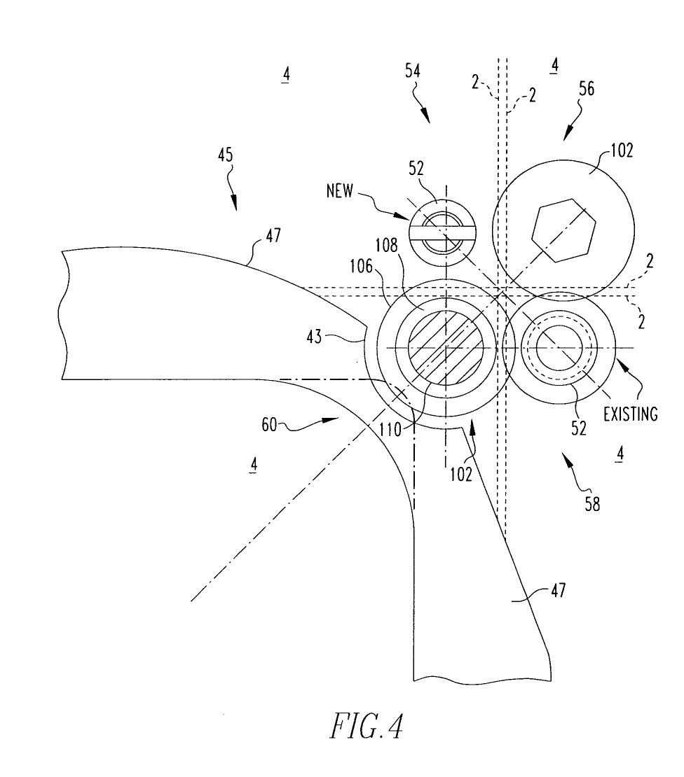

As shown in FIG. 4, in order to accommodate the spring pack housing 106, a partial arcuate cut-out 43 in the flange 47 (see also FIG. 2) of the guide tube 45 (e.g., control rod enclosures) is required. Such a modification does not unacceptably degrade the integrity of the flange 47 because well established industry stiffness and stress level standards are maintained. It will also be appreciated that, if the cut-out 43 were to raise a concern, the flange 47 could be made thicker to compensate for the material removed for the arcuate cut-out 43.

Continuing to refer to FIG. 4, two fuel assembly alignment pin 52 locations are shown. The known alignment pin location of the prior art is labeled EXISTING and the new location in accordance with the restraint assembly 100 of the invention is labeled NEW. Specifically, the top nozzle 4 of each fuel assembly 2 has four corners 54, 56, 58, 60 (best shown in FIG. 8). As best shown in FIG. 8, two opposed corners 54, 58 have bored holes 62, 64 which receive a fuel alignment pin 52 (best shown in FIG. 3). The alignment pins 52 extend through and protrude below the upper core plate 42 (FIG. 3). The remaining two corners 56, 60 are essentially pads which, as previously discussed, are where the spring pack push rods 110 (FIG. 3) bear and apply a downward force as the coil springs 108 are compressed (FIG. 3). FIG. 4 generally shows a portion of the top nozzle 4 for each of the four adjacent fuel assemblies. One corner 54, 56, 58, 60 is shown, respectively, for each of the four adjacent top nozzles 4. The vertical and horizontal parallel-dashed lines schematically represent the adjacent edges of the top nozzles 4.

Accordingly, as confirmed by the foregoing EXAMPLE, the restraint assembly 100 of the present invention eliminates the known at least four cantilever spring 22 (FIGS. 1 and 3 (phantom line drawing)) per fuel assembly design and replaces it with an improved two spring pack 102 restraint assembly which uniformly distributes a sufficient amount of compressive load on the fuel assembly 2 without causing column bowing. Additional advantages of the spring pack design will be further appreciated with reference to the free body diagrams of FIGS. 7A, 7B, 7C and 7D discussed hereinbelow. It will be appreciated that the foregoing is but one example of an application for the in-core restraint assembly 100 and, in particular, the spring packs 102 therefor, of the present invention. For example, it will be appreciated that any suitable alternative number of spring packs 102 (e.g., three or more spring packs) (not shown) and configuration (not shown) of spring packs 102, could be employed.

As shown in FIG. 5, to supplement the aforementioned spring packs 102, the restraint assembly 100 of the invention further includes a split-pin assembly 104 for restraining the bottom portion of each fuel assembly 2 and, in particular, the bottom nozzle 6. The exemplary split-pin assembly 104 includes a clothespin-like split-pin 128 which is positioned and secured on the axial centerline 130 of the fuel assembly bottom nozzle 6. The split-pin 128 includes a first end 132 which is disposed within the bottom nozzle 6 and structured for engagement with the instrument tube 14 (only partially shown in FIG. 5; see also FIGS. 1 and 2) and a second end 134 which protrudes below the bottom nozzle 6. The second end 134 includes an elongated slot 136 defining a pair of leaves 138, 140 giving the exemplary split-pin 128 a structure similar to a clothespin. The leaves 138, 140 are compressible laterally inward toward one another, much as the leaf portions at the slot of a clothespin provides a lateral compressive force to secure an article of clothing to a clothesline. The leaves 138, 140 of the exemplary split-pin 128 are designed to provide a significant frictional force when inserted into a socket 150 coupled to the lower core support plate 44 (split-pin 128 is shown in the engaged position within socket 150, in phantom line drawing in FIG. 5).

Specifically, split-pin 128 is generally cylindrical in shape, having an outer diameter 142 at the leaf portion (e.g., second end 134) thereof. This outer diameter 142 is slightly greater than the diameter 152 of the bore 154 of socket 150 into which it is inserted. In this manner, the compressibility of the leaves 138, 140 of the split-pin 128 results in a laterally outward (e.g., normal) force on the wall 153 of bore 154 of the socket 150. This normal force is the result of the leaves 138, 140 being compressed when inserted into the socket 150 and the corresponding radially outward force they produce as they try to return to their natural, uncompressed position. This outwardly compressive normal force provides substantial friction between the split-pin 128 and socket 150 thereby resisting undesired axial movement (e.g., lift off) of the fuel assembly 2 (not shown in FIG. 5). The exemplary split-pin assembly 104, is therefore, an extremely effective supplement to the aforementioned spring packs 102 for providing in-core restraint of the fuel assembly 2.

Accordingly, the unique combination of spring packs 102 and the split-pin assembly 104 of the exemplary in-core restraint assembly 100 substantially overcomes many disadvantages of known restraint mechanisms (e.g., without limitation, cantilever springs 22 of FIG. 1). For example, the restraint assembly 100 of the present invention provides sufficient fuel assembly 2 (FIG. 1) restraint to prevent potential lift-off (e.g., separation of the fuel elements from the core plate) in the case of short fuel assemblies where coil or cantilever spring axial compressive forces are at a minimum, and, in cases of an unusual transient or coolant pump overspeed, for example, where upward coolant flow forces acting along the fuel assembly 2, (FIG. 1) are increased. The multiple compression and friction based restraint forces of the exemplary spring pack 102 and split-pin assembly 104 combination effectively combat such forces and the potential undesirable consequences thereof.

Continuing to refer to FIG. 5, the details of the exemplary socket 150 can be appreciated. Specifically, the exemplary socket 150 consists of a machined member preferably made from a metallic material which exhibits properties compatible with the environment of a nuclear reactor application. One example of such a material, without limitation, is Inconel Alloy. It will, however, be appreciated that any known or suitable alternative material could be used to make the socket 150 and that the socket 150 may be made from any suitable alternative process other than machining.

The socket 150 includes the aforementioned bore 154 with a diameter 152 slightly smaller than the outer diameter of the leaf portion 134 of the pin socket 104. By way of a non-limiting representative example, in the aforementioned EXAMPLE of the Westinghouse AP-1000 core design, the bore diameter 152 of the socket 150 is between about 0.732 to 0.735 inches (1.86 to 1.87 centimeters). The outer diameter 142 of the leaf portion 134 of split-pin 128 is slightly larger, between about 0.748 to 0.752 inches (1.90 to 1.91 centimeters). The dimensional difference requires the split-pin 128 to be force-fit within the bore 154 of socket 150, thereby generating the desired frictional restraint forces. Specifically, in this same EXAMPLE, the aforementioned normal forces generated by the leaves 138, 140 of the split-pin 128 will be approximately equivalent to a longitudinal friction force in the range of between about 950 to 1,150 pounds (430.91 to 521.63 kilograms) force. It is important to note that, for example, a fuel assembly, whose hot buoyant weight is 1,581 lb., readily overcomes this longitudinal friction force when being loaded into the core so there is no hang-up for proper seating. Alternatively, the pull force necessary to remove a fuel assembly (e.g., overcome the friction force ) does not overstress any of the structural welds or fasteners which hold the fuel assembly together.

The exemplary socket 150 further includes a radial flange 156 having a number of holes 158 for receiving fasteners 160 therethrough in order to secure the socket 150 to the lower core support plate 44, as shown in FIG. 5. In FIG. 5, one hole 158 is shown with a single corresponding screw 160 threadingly securing the flange 156 to core plate 44. However, it will be appreciated that any number of fasteners (e.g., screws 160) could be used. It will also be appreciated that any suitable alternative method for securing the socket 150 to the lower core plate 44, other than the exemplary bolted or screwed flange 156, could alternatively be employed. For example, the lower core support plate 44 could be adapted to provide an integral socket, as opposed to separate socket 150.

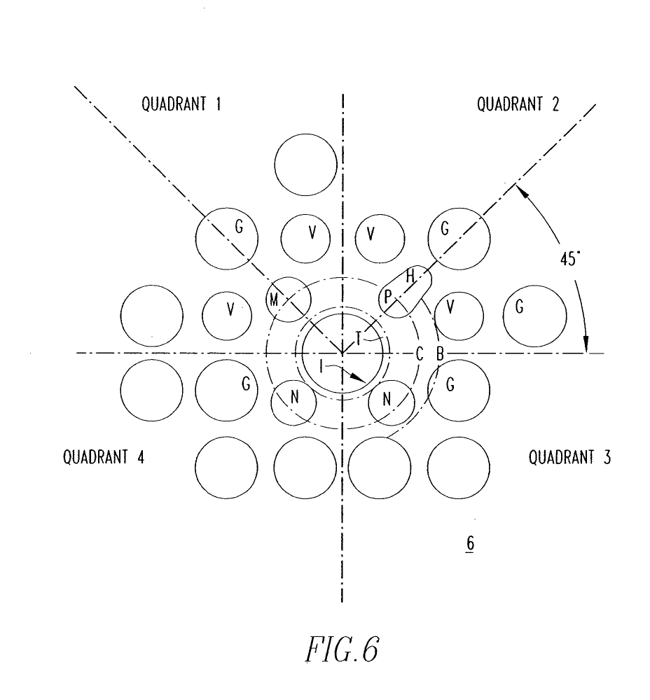

FIG. 6 provides a schematic depiction of the affects of the foregoing split-pin assembly 104 on the flow hole configuration of the fuel assembly bottom nozzle 6. The bottom nozzle 6 shown in the example of FIG. 6 is for a fuel assembly 2 commonly referred to in the art as a 17×17 assembly. All four quadrants (labeled quadrant 1, quadrant 2, quadrant 3 and quadrant 4 in FIG. 6) of the bottom nozzle 6 are shown. Quadrants 3 and 4 show the existing flow hole pattern which includes I, N, and G flow holes having diameters of about 0.483 inch (1.23 centimeter), about 0.280 inch (0.71 centimeter) and about 0.376 inch (0.96 centimeter), respectively. The dimensions assigned to these holes (e.g., I, N, G holes) are consistent in all four quadrants. The letter designations (e.g., I, N, G) have been assigned to provide for simplicity of illustration. Quadrants 1 and 2 have been modified to show two representative flow hole pattern alternatives for accommodating the exemplary split-pin assembly 104.

In the first example alternative hole pattern of quadrant 1, the flow hole pattern has been modified to reposition the N holes in order to provide about 0.081 inch (0.206 centimeter) ligament, or width of material, to diameter T. Diameter T is the outside diameter of the split-pin 128. Additionally, in the quadrant 1, the two adjacent G holes have been reduced in diameter to V holes having a diameter of about 0.312 inch (0.79 centimeter).

In the second example alternative modified flow hole example of quadrant 2, the N hole is replaced with an oblong P/H hole, having a larger P diameter of about 0.250 inch (0.635 centimeter) and tapering to a smaller H diameter of about 0.187 inch (0.475 centimeter), as shown. The ligament between P and T is again about 0.081 inch (0.206 centimeter). By way of comparison, the area of a standard N hole is approximately 0.123 square-inches (0.794 square-centimeters). The P/H hole of the modified flow hole pattern of quadrant 2 has an increased area of about 0.153 square-inches (0.987 square-centimeters). This increased area, combined with the other flow hole modifications of quadrant 2, provides additional coolant flow which, among other benefits, achieves a more uniform coolant flow distribution and slight reduction in pressure differential across the nozzle 6. Finally, in the example of quadrant 2, the two adjacent G holes are reduced in diameter to V holes. It will be appreciated that quadrants 1 and 2 of FIG. 6 merely present two possible flow hole patterns capable of accommodating the addition of the split-pin assembly 104 of the exemplary in-core restraint assembly 100 while continuing to provide sufficient coolant flow through the core 30 (FIG. 2). Any known or suitable alternative bottom nozzle 6 flow hole pattern (not shown) could also be employed. For example, an oval flow hole (not shown) could be employed.

In the example shown and described herein, the split pin 128 is disclosed as being positioned on the axial center-line of the fuel assembly 102, which is the most convenient location. However, it will be appreciated that if, for example, the nuclear plant has bottom mounted in-core instrumentation (e.g., fluxdetectors; thermocouples) (not shown), the central position might not be available and, therefore, two smaller split pins (not shown) could be incorporated on two diagonal feet of the fuel assembly 102 instead of the exemplary single, central split pin restraint assembly 104.

FIGS. 7A, 7B, 7C and 7D provide a comparison between known compressive spring restraint mechanisms (see, e.g., cantilever springs 22 discussed previously in connection with FIGS. 1 and 3) and the improved in-core restraint assembly 100 of the present invention. The figures are schematic free body diagrams illustrating the forces experienced by an individual fuel assembly 2. Specifically, (FIGS. 7A and 7B) show the forces exerted, by the prior art cantilever springs (e.g., springs 22 of FIG. 1), on the fuel assembly 2 under hot and cold beginning of life (BOL) and end of life (EOL) reactor core conditions, respectively. For comparison, FIGS. 7C and 7D show free body diagrams illustrating the forces exerted by the exemplary in-core restraint assembly 100 under the same core conditions. The examples of FIGS. 7A, 7B, 7C and 7D are merely provided to illustrate and further clarify the benefits offered by the present invention and not limiting upon the scope of the invention.

The free body diagram forces illustrated in FIGS. 7A, 7B, 7C and 7D are representative of the aforementioned Westinghouse AP-1000 design EXAMPLE having 157 fuel assemblies 2. The forces shown assume a 14% inlet flow maldistribution. The buoyant weight of the fuel assembly 2 remains constant at 1,581 pounds (717.13 kilograms) hot, 1,521 pounds (689.91 kilograms) cold in all of the free body diagrams of FIGS. 7A-7D. As shown by the comparison of FIGS. 7C and 7D versus FIGS. 7A and 7B, with the adoption of the spring packs 102 of the present invention, in combination with the split-pin assembly 104, the forces at the top nozzle 4 can be reduced in order to resist the problem of fuel element column bowing. Specifically, under hot beginning of life (BOL) core conditions the prior art imposed a compressive axial force of about 1,073 pounds (486.70 kilograms) on the top of the fuel assembly 2 (FIG. 7A). The restraint assembly 100 (e.g., spring packs 102 and split-pin 104) of the present invention substantially reduces this force to about 610 pounds (276.69 kilograms) under the same conditions (FIG. 7C). Continuing to compare FIGS. 7A and 7C, under hot end of life (EOL) core conditions, the axial force exerted by the known cantilever spring 22 (FIG. 1) on the fuel assembly 2 increases to 1,650 pounds (748.43 kilograms). Under the same conditions, the exemplary spring packs 102 of the present invention exert substantially the same force of 1,660 pounds (752.96 kilograms).

A more significant reduction in undesirable axial compressive forces is appreciated with reference to FIGS. 7B and 7D which compare the forces of the old (FIG. 7B) and new (FIG. 7D) restraint designs on the fuel assembly 2 under cold BOL and EOL conditions, respectively. For example, the old force of 2,679 pounds (1,215.17 kilograms) is reduced to 1,294 pounds (586.95 kilograms) under cold BOL conditions and, under cold EOL conditions, the prior force of 3,254 pounds (1,475.99 kilograms) (FIG. 7B) is substantially reduced to 2,343 pounds (1,062.77 kilograms).

It is also important to note, with reference to FIGS. 7A-7D that in the worst case scenario, cold BOL, the spring packs 102 alone still hold the fuel assembly down with a net force of 10 pounds (4.54 kilograms). Therefore, the split pin restraint assembly 104 never comes into play until the reaction force on the lower core support plate 44 goes to zero. Additionally, the lift force of 2,805 pounds (1,272.33 kilograms) is conservatively high, which further demonstrates that the split pin restraint 104 is effectively a “reserve” restraint mechanism and, theoretically is not needed as all of the free-body diagrams of FIGS. 7A-7D indicate.

Accordingly, the foregoing EXAMPLE confirms the effectiveness of the in-core restraint assembly 100 at reducing undesirable, harmful compressive forces to an acceptable level, thereby avoiding undesirable associated effects, such as, without limitation, column bowing of fuel assembly elements (e.g., fuel rods 12 and guide thimbles 8 of FIG. 1), while simultaneously maintaining sufficient restraint of the assembly 2 against other undesirable movement, such as lift-up. In addition to the aforementioned benefits of reduced clamping forces and the ability to contain fuel assemblies 2 under a wide variety of temperature and flow conditions, the in-core restraint assembly 100 of the present invention also provides several additional advantages.

For example, the thickness of the upper and lower core plates 42, 44 (FIG. 2) can be reduced due to the reduction in axial compressive forces on the fuel assemblies 2 (FIG. 1), which translates to equal and opposite forces on the core plates 42, 44. For instance, with respect to the previous EXAMPLE (e.g., Westinghouse AP-1000) discussed herein throughout, the upper core plate 42 can be reduced by about 0.75 inch (1.91 centimeters) from a thickness of about 3.00 inches (7.62 centimeters) down to about 2.25 inches (5.715 centimeters) and the lower core plate 44 can also be reduced by about 0.75 inches (1.91 centimeters) from about 15.00 inches (38.10 centimeters) to about 14.25 inches (26.20 centimeters). This results in material and manufacturing cost savings. It also increases the distance between the core plates 42, 44 by about 1.5 inches (3.81 centimeters), having gained about 0.75 inches (1.91 centimeters) from each core plate 42, 44. Also, with the removal of the cantilever springs (FIG. 1), the fuel assembly top nozzle 60 can be shortened by approximately 0.5 inches (1.27 centimeters), bringing the total to 2.0 inches (5.08 centimeters). This enables a variety of additional, optional benefits.

For example, the 2.0 inches (5.08 centimeters) gained length could be taken out of the pressure vessel 32 (FIG. 2) length or height, which would result in the benefit of reducing reactor containment size. Such a modification translates into less coolant, or water, volume existing in the pressure vessel 32, meaning that less would be released as effluent in a loss of coolant accident. Additionally, the smaller pressure vessel 32 would be lighter. In the EXAMPLE discussed hereinbefore, the approximate weight reduction would be about 3,066 pounds (1,391 kilograms).

Alternatively, a second option would be to add 2.0 inches (5.08 centimeters) of active fuel. In the AP-1000 EXAMPLE, this would mean extending the fuel from about 168 inches (426.72 centimeters) to about 170 inches (431.80 centimeters), which is equivalent to an increase in power of about 1.2% (e.g., 13 mega-watts electric power). As another alternative, instead of adding 2.00 inches (5.08 centimeters) of additional fuel length, the additional 2.00 inches (5.08 centimeters) could be used between core plates 42, 44 in order to increase the open volume in a particular fuel rod (e.g., the area between the top of the fuel stack and the upper fuel rod closure seal) and accommodate any excessive gas release from the fuel.

A still further alternative would be to increase the pressure vessel 32 counter bore length (e.g., depth) by about 1.5 inches (3.81 centimeters). The vessel counter bore is the vessel mating location where the lower reactor flange 47 (FIG. 2) rests. This added depth can be used, for example, to increase the thickness of the reactor internals hold down spring (not shown) in order to provide superior restraint for lower reactor internals against lifting and vibration.

One other possibility is to move the lower core support plate 44 up 2.60 inches (5.08 centimeters), leaving the pressure vessel length the same. This would increase the lower vessel plenum 39 height by 2.00 inches (5.08 centimeters) and improve core inlet flow distribution, (e.g., make it more uniform). Thinning the upper core support plate by 0.75 inches (1.91 centimeters) also has a secondary benefit of reducing thermal stresses generated by internal heating due to core radiation, which results in a greater safety margin.

It will be appreciated that the benefits of the exemplary in-core restraint assembly 100 are not limited to the foregoing. It will also be appreciated that any one of the aforementioned beneficial design changes could be selected or, alternatively, a combination of such design changes, could be derived.

It will further be appreciated that, while the fuel assembly 2 illustrated (FIG. 1) and described herein is of the type having a generally square array of fuel rods 12 with control rod guide thimbles 8 being strategically arranged within the array, and the top and bottom nozzles 4, 6 and support grids 10 are generally square in cross-section, that neither the shape of the nozzles 4, 6 or the grids 10, nor the number and configuration of the fuel rods 12 and guide thimbles 8 are to be limiting on the present invention. The invention is equally applicable to reactor core components having different shapes, configurations and arrangements than the ones shown and described herein.

Accordingly, the in-core restraint assembly 100 of the present invention provides a unique combination of spring packs 102 and a novel split-pin assembly 104, which restrains the fuel assembly 2 under all variations of reactor conditions while simultaneously overcoming the disadvantages of known restraint mechanisms.

The exemplary restraint assembly 100 also provides numerous reactor improvements and advantages. Among them are the fact that the exemplary spring packs 102 are not discarded at each core reload cycle. Therefore, there are no recurring costs and the initial cost of the new restraint assembly 100, and of any additional affiliated machining required to accommodate the spring packs 102 on the upper core plate 42, is soon recouped. Although the split-pin assembly 104 is discarded along with a spent fuel assembly 2, the manufacturing cost savings of the exemplary restraint assembly 100, in comparison with known restraint designs, are significant and, there is less radioactive material to be disposed of or stored. Also, because the core life of the split-pin assemblies 104 is only about 3 cycles or about 54 months, time-dependent IASCC induced failure of the pins is not a concern even though they are situated in a relatively high neutron fluency zone. Additionally, the overall fuel assembly 2 length is also decreased by approximately 2.0 inches (5.08 centimeters) by eliminating the relatively large prior art cantilever springs (see, e.g., cantilever springs 22 of FIGS. 1 and 3). This results in the added benefits of, among others, reduced fuel storage cell height in the spent fuel pit, reduced size of the containers required to be used to store spent fuel on site, of fuel assembly shipping containers, and on-site fuel transfer equipment. Elimination of the bulky cantilevered springs (e.g., springs 22) also simplifies on-site fuel handling in general, by substantially reducing the propensity for damage to the fuel assembly 2. This efficiency improvement in handling and transfer will also result in a modest decrease in a refueling outage.

Moreover, as previously discussed, changes made to the top nozzle 4 in order to accommodate the exemplary spring packs 102 improve coolant flow and distribution, making it more uniform and advantageously reducing the pressure differential across the nozzle 4. In this regard, in addition to the aforementioned flow hole pattern modifications, as shown in FIG. 6, a previously large top nozzle corner radius (best shown in FIG. 8) of about 1.75 inch (4.45 centimeter) is reduced to about 0.5 inch (1.27 centimeter). The cross-hatched corner region proximate corner 60 of FIG. 8 indicates the additional area of material which is removed (e.g., milled out) from the exemplary top nozzle 4. This further facilitates the aforementioned coolant flow improvements.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. An in-core restraint assembly for a nuclear reactor core including an upper core support plate, a lower core support plate and a plurality of fuel assemblies extending longitudinally therebetween, each of said fuel assemblies including a longitudinal axis, a top nozzle, a bottom nozzle and a plurality of elongated fuel rods extending therebetween, said in-core restraint assembly comprising:
a pair of spring packs structured to be an integral part of said upper core support plate and to provide a substantially axial compressive force on diagonal corners of said top nozzle of said fuel assembly, in the direction of said longitudinal axis.

2. An in-core restraint assembly for a nuclear reactor core including an upper core support plate, a lower core support plate and a plurality of fuel assemblies extending longitudinally therebetween, each of said fuel assemblies including a longitudinal axis, a top nozzle, a bottom nozzle and a plurality of elongated fuel rods extending therebetween, said in-core restraint assembly comprising:
a first restraint element structured to be coupled to said upper core support plate separate from said control rod guide thimbles and to provide a substantially axial compressive force on said top nozzle of said fuel assembly, in the direction of said longitudinal axis; and
a second restraint element structured to be coupled to said lower core plate in order to positively axially engage said bottom nozzle of said fuel assembly and to further restrain said fuel assembly.

3. The in-core restraint assembly of claim 2 wherein said second restraint element includes a pin member and a socket, said pin member structured to extend from said bottom nozzle of said fuel assembly, said socket structured to be coupled to said lower core support plate and adapted to receive said pin member.

4. The in-core restraint assembly of claim 2 wherein said first restraint element is structured to provide said substantially axial compressive force on diagonal corners of said fuel assembly.

5. The in-core restraint assembly of claim 2 wherein said upper core plate has a top surface and includes a counter-bore; and wherein said first restraint element is a spring pack comprising:
a housing including a top end and a bottom end;
a resilient element disposed within said housing; and
a push rod,
wherein said resilient element and said push rod are structured to be received within said counter-bore of said upper core plate and, the bottom end of said housing is structured to be coupled to the top surface of said upper core plate.

6. The in-core restraint assembly of claim 5 wherein said spring pack further includes a retainer element and a cap structured to be secured within the top end of said housing adjacent said resilient element in order to hold the components of said spring pack together.

7. The in-core restraint assembly of claim 5 wherein said resilient element is a coil spring.

8. The in-core restraint assembly of claim 5 wherein each of said fuel assemblies includes two of said spring packs.

9. The in-core restraint assembly of claim 3 wherein said pin member is a split-pin including a first end structured to be disposed in said bottom nozzle of said fuel assembly and, a second end structured to protrude below said bottom nozzle; and wherein the second end of said split-pin includes an elongated slot defining a pair of leaves, said leaves being compressible laterally in order to provide a frictional resistance force when inserted into said socket.

10. The in-core restraint assembly of claim 9 wherein said socket consists of a machined member having a bore with a diameter, said diameter being smaller than the outer diameter of said pair of leaves of said split-pin; and wherein said split-pin is structured to be force-fit within said bore of said machined member.

11. The in-core restraint assembly of claim 3 wherein said socket includes a radial flange having a number of holes each structured to receive a fastener therethrough, in order to secure said socket to said lower core support plate.

12. A nuclear reactor core comprising:
an upper core support plate;
a lower core support plate;
a plurality of fuel assemblies extending longitudinally between said upper core support plate and said lower core support plate, each of said fuel assemblies including a longitudinal axis, a top nozzle, a bottom nozzle and a plurality of elongated fuel rods extending therebetween; and
an in-core restraint assembly for securing said fuel assemblies between said upper and lower core support plates, said in-core restraint assembly comprising:
a first restraint element coupled to said upper plate and structured to provide a substantially axial compressive force on said top nozzle of said fuel assembly, in the direction of said longitudinal axis, and
a second restraint element coupled to said lower core plate in order to positively axially engage and further restrain said fuel assembly.

13. The nuclear reactor core of claim 12 wherein said second restraint element includes a pin member and a socket, said pin member extending from said bottom nozzle of said fuel assembly, said socket being coupled to said lower core support plate in order to receive said pin member.

14. The nuclear reactor core of claim 12 wherein said first restraint element is structured to provide said substantially axial compressive force on diagonal corners of said fuel assembly.

15. The nuclear reactor core of claim 12 wherein said upper core plate has a top surface and includes a counter-bore; and wherein said first restraint element is a spring pack comprising:
a housing including a top end and a bottom end; and
a resilient element disposed within said housing; and
a push rod,
wherein said resilient element and said push rod are received within said counter-bore of said upper core plate and, the bottom end of said housing is coupled to the top surface of said upper core plate.

16. The nuclear reactor core of claim 15 wherein said spring pack further includes a retainer element and a cap structured to be secured within the top end of said housing adjacent said resilient element in order to hold the components of said spring pack together.

17. The in nuclear reactor core of claim 15 wherein said resilient element is a coil spring.

18. The nuclear reactor core of claim 15 wherein each of said fuel assemblies includes two of said spring packs.

19. The nuclear reactor core of claim 13 wherein said pin member is a split-pin including a first end structured to be disposed in said bottom nozzle of said fuel assembly and, a second end structured to protrude below said bottom nozzle; and wherein the second end of said split-pin includes an elongated slot defining a pair of leaves, said leaves being compressible laterally in order to provide a frictional resistance force when inserted into said socket.

20. The nuclear reactor core of claim 19 wherein said socket consists of a machined member having a bore with a diameter, said diameter being smaller than the outer diameter of said pair of leaves of said split-pin; and wherein said split-pin is structured to be force-fit within said bore of said machined member.

21. The nuclear reactor core of claim 13 wherein said socket includes a radial flange having a number of holes each structured to receive a fastener therethrough, in order to secure said socket to said lower core support plate.

22. The nuclear reactor core of claim 12 wherein said upper core plate has a thickness of about 2.25 inches; and wherein said lower core plate has a thickness of about 14.25 inches.

23. The nuclear reactor core of claim 12 wherein said top nozzle has an outer perimeter, an inner perimeter, and four corners; wherein said outer perimeter of said top nozzle has a substantially square shape when viewed from a top plan perspective; and wherein at least one of said corners has a radius of about 0.5 inches in order that said at least one of said corners is rounded.

24. The in-core restraint assembly of claim 1 wherein said nuclear reactor core further comprises a plurality of control rod guide thimbles extending between said top nozzle and said bottom nozzle; and wherein said spring packs are separate from said control rod guide thimbles.

25. The in-core restraint assembly of claim 2 wherein said nuclear reactor core further comprises a plurality of control rod guide thimbles extending between said top nozzle and said bottom nozzle; and wherein said first restraint element is separate from said control rod guide thimbles.
